(19) United States
(12) Patent Application Publication
(10) Pub. No.: US 2026/0080480 A1
(43) Pub. Date: Mar. 19, 2026

(54) AUTOMATED QUOTE COMPARISON AND GRAPHICAL RISK STRUCTURE GENERATION FROM UNSTRUCTURED INSURANCE QUOTATION DOCUMENTS

(71) Applicant: Aon Global Operations SE, Singapore Branch, Singapore (SG)

(72) Inventors: Raju Debroy, Hoffman Estates, IL (US); Sudipto Shankar Dasgupta, Sunnyvale, CA (US); Dermot Manning, Kildimo (IE); Clyde Bernstein, Stowmarket (GB)

(73) Assignee: Aon Global Operations SE, Singapore Branch, Singapore (SG)

(21) Appl. No.: 19/050,490

(22) Filed: Feb. 11, 2025

Related U.S. Application Data
(60) Provisional application No. 63/695,517, filed on Sep. 17, 2024.

(51) Int. Cl. G06Q 40/08; G06F 16/36

(52) U.S. Cl. CPC G06Q 40/08; G06F 16/367

(57) ABSTRACT

In an illustrative embodiment, systems and methods for extracting, and organizing, and visualizing details of options provided by multiple organizations responsive to a risk fulfillment request include analyzing unstructured electronic documents to recognize various quote aspects in their contents, label the quote aspects according to a classification, and store semantically linked quote aspects. The systems and methods, for example, may enhance semantically-linked groups of quote aspects with attributes according to a corresponding ontology, and confirm the labeling, grouping, and enhancing through feedback interactions performed with a user via a graphical display. The confirmed information may be used to generate a visualization of options for fulfilling the request, each option qualified and/or color-coded through automated learned analysis for review by the user.

### RELATED APPLICATIONS

The present disclosure claims the benefit of and priority to U.S. Provisional Patent Application Ser. No. 63/695,517 filed Sep. 17, 2024, incorporated herein by reference in its entirety.

### BACKGROUND

When a client decides to transfer risk from their balance sheet to another risk-bearing entity, it is the broker's job to design insurance coverage programs that best achieve the client's risk strategy. During the risk-transfer exercise (placement), brokers may approach different (re)insurance carriers to discover the solutions available from the insurance market. Placement often involves multiple brokers, frequently across different geographies, approaching many (re)insurance carriers. For example, in commercial insurance, the size and risk complexity of corporate clients often necessitates (re)insurance programs being spread or syndicated across many (re)insurance carriers. The placement process helps clients to discover the underwriting appetite of the (re)insurance market to the client's risk profile and to identify the terms and conditions on which the (re)insurance carriers are willing to insure the client's risk. When (re)insurance carriers propose terms for covering portions of the client's risk, they frequently provide several quote options. This initial placement process results in a wealth of information to digest, and these different terms and conditions need to be assessed quickly.

Additionally, having secured offers of (re)insurance from the market, brokers will frequently re-approach carriers to renegotiate terms or seek additional quote options. Thus, the placement process can lead to many combinations of quotes and options all of which are presented to brokers in a non-uniform manner, making the quote collation, comparable assessment and recommendation process administratively complex and prone to human error.

To further complicate matters, each insurance carrier sets out quotation terms in a different internal format. For example, coverage language is rarely expressed consistently, with each carrier using different definitions to describe similar coverage attributes and elements. The form in which individual quotes are received may also vary, from unstructured quote language supplied in the body of an email (e.g., unstructured contents of a document) to unstructured (natural language) or semi-structured (consistently formatted) quote documents (e.g., email attachments). A semi-structured document, for example, may be formatted in a manner consistent to a particular carrier such that the arrangement of information within the semi-structured document is capable of being at least partially recognized based on a recognized document layout. Each individual document, in some examples, may be formatted as a spreadsheet (e.g., Excel), a word processor document (e.g., Microsoft Word), or a portable/graphical document (e.g., PDF). The variability and volume pose an operational challenge to brokers. Before quotes can be reviewed and analyzed on a like-for-like basis, and prior to placement updates, advice and recommendations are made to the client, quote data needs to be gathered from the multiple documents, collated, and standardized. This time-intensive and laborious task opens further business risk such as operational risk and governance.

Due to the large volume of information gathered during the initial quote process and the time-critical nature of the process, customarily, brokers will use their placement experience and knowledge of trading in the market to determine which quote offer(s) to take forward to the client, leaving other options on the cutting room floor. Thus, the legacy platforms, non-standard data, and lack of end-to-end placement technology results in placement decisions relying on individual subjective analysis that will not always be free from bias.

Furthermore, quotes that are not taken forward to the client have not been historically captured in downstream broking applications. This has several implications including a loss of intelligence about the theoretical capacity and appetite in the market. For example, although one (re)insurer's term may not be perceived to be as competitive as another (re)insurer's term, the placement process has discovered a willingness to supply. Clients with specific coverage requirements or outsized limit demands, for example, would benefit from knowing that this supply exists and what the trade-off or concessions may be to achieve their risk-transfer objectives. The limited use of both quantitative and qualitative data-informed decisions in today's manual broking process may negate a more nuanced and measured data-informed consideration about counterparties. In one example, additional knowledge may be derived regarding the willingness to pay claims and not simply the financial ability to pay. In a second example, capturing counter-parties'quote information may provide insight into carrier evolving risk appetite and long-term commitment.

Frequently, an insurance broker must manually process a large quantity of documents to piece together a “layered and shared” coverage structure to allocate the risk among numerous carriers with varying risk appetites. To assist in the decision process related to the wealth of options, graphical illustrations of the intended risk structure—sometimes called “mud maps” by brokers—may be drawn and delivered to the client at key placement stages. Given the complexities of regulations within the insurance market across multiple carriers, the generation of the mud-maps is time consuming and involves significant manual efforts.

The inventors recognized the need to automate the analysis of insurance quotation documents to improve the speed and productivity of brokers, while providing a higher quality and sophistication in client advice. By embedding quote data insights into the placement process at the point of trade, brokers and clients may be assisted in making better risk-transfer and vendor decisions, beyond the binary raw cost of premium. The inventors recognized that automatic processing of insurance quote documents could transform today's manual broking activities spanning insurance carrier selection, negotiation, quoting, assessment, visualization, and recommendation.

### SUMMARY OF ILLUSTRATIVE EMBODIMENTS

In one aspect, the present disclosure relates to systems and methods for ingesting unstructured or semi-structured documents to extract and organize transactional information found therein. The transactional information, for example, may include quote offers from various third-party risk coverage entities (e.g., insurance and/or reinsurance carriers) provided to a risk coverage intermediary (e.g., broker) responsive a request regarding risk coverage options for an entity (i.e. client of the broker). The client entity, in some examples, may include a corporation, business organization, non-profit organization, or other entity. The documents, in some examples, may include emails, attachments to emails, voicemail recordings, electronic facsimile (e-fax) documents, and/or other electronically shared documents (e.g., exchanged via a platform, file transfer service, etc.).

The unstructured and semi-structured documents, in illustration, arrive through various means of electronic communications (e.g., emails, document attachments, voicemails, facsimiles, etc.) from insurance carriers providing risk coverage products on a national or global scale. Each insurance carrier's documentation, in addition to arriving in various documentation formats, will vary in its arrangement, terminology, and depth of content. Further, during negotiations, follow-on quote offers (e.g., updated risk coverage options) may be received, supplementing and/or supplanting prior quote offers. The collective information related to a single client risk coverage strategy, therefor, arrives in a disorganized trickle of documentation incompatible to easy combination and analysis. Thus, the systems and methods described herein for ingesting, extracting, and organizing transactional information from unstructured and/or semi-structured documents provides a technical solution, not available at the time of filing the present disclosure, to organizing and digesting digital quote offer transmissions in a consistent, subjective, and swift fashion. The information, for example, may be digested in real-time or near real-time to its receipt. In another example, the documents, once collected (e.g., stored by the broker and/or identified and archived by the methods and systems described herein for later analysis), may be analyzed in a manner of minutes rather than the days or weeks required for manual review by a broker.

In some embodiments, the transactional information is analyzed to extract terms corresponding to transactional information. For example, natural language processing may be applied to recognize the text within each unstructured or semi-structured document. A business ontology may be applied to classify terms or phrases in the transactional information according to document attributes (e.g., transaction elements). An end user may be prompted to confirm, via a graphical user interface, the classified terms or phrases.

In illustration, the analysis and extraction provides, to the end user (e.g., broker), an automated tool to swiftly and consistently perform formatting, cleansing, and enrichment actions required to piece together the client's quote offer options.

In some embodiments, the extracted terms are organized into vector formats for artificial intelligence and/or machine learning analysis. The extracted terms, for example, may be stored into a semantic graph according to a semantic ontology. An end user may be prompted to confirm the relationships applied to the extracted terms according to the semantic ontology.

In one aspect, the present disclosure relates to systems and methods for generating a graphical quote comparison through analyzing automatically collated insurance or reinsurance quote information. The (re)insurance quote information may be automatically collated, for example, from unstructured and/or semi-structured documents submitted to a broker by multiple insurance or reinsurance carriers. Information extracted from the unstructured and/or semi-structured documents, further to the example, may be classified into document attributes and analyzed to discover relationships between the document attributes. Machine learning and/or artificial intelligence may analyze the collated quote information to generate the graphical quote comparison. The graphical quote comparison may represent a portion of the automatically collated insurance or reinsurance quote information deemed responsive to the goal of a corresponding risk fulfillment transaction request (e.g., fulfilling at least a portion of risk requirements of a client).

In some embodiments, the graphical quote comparison includes a table presenting multiple options for coverage corresponding to types and layers of insurance or reinsurance. The options may be arranged and/or qualified (e.g., ranked, color-coded, etc.) to identify preferred or recommended options.

In illustration, the quote options may be qualified (e.g., best value to the client, best match to fulfilling the client's needs, etc.) in a consistent, objective fashion based on applying machine learning and/or artificial intelligence that has learned from a multitude of historic data how to recognize best options to a client. Although the broker and client, in discussing, ultimately select the best options for fulfilling the client's risk coverage needs, the quote qualification process removes some human subjectivity during quote offer consideration. Further, the quote options may be qualified in light of the client's coverage needs, thus flagging and/or winnowing out quote offers that do not fulfill or align with the client's goals.

In one aspect, the present disclosure relates to systems and methods for automatically generating a complex quote structure through analyzing automatically collated insurance quote information. The (re)insurance quote information may be automatically collated, for example, from unstructured and/or semi-structured documents submitted to a broker by multiple insurance or reinsurance carriers. Information extracted from the unstructured and/or semi-structured documents, further to the example, may be classified into document attributes and analyzed to discover relationships between the document attributes. Machine learning and/or artificial intelligence may analyze the collated quote information to generate quote comparisons, preparing comparative metrics regarding the aspects and/or perceived value (e.g., desirability) of each quote option. The complex quote structure may represent a portion of the automatically collated insurance or reinsurance quote information deemed responsive to the goal of a corresponding request (e.g., fulfilling at least a portion of risk requirements of a client). The complex quote structure, for example, may correspond to a provisional structure representing the risk coverage requirements of a client of the broker.

At the time of filing, in illustration, each broker would take on the “art project” of mud-mapping various options to visually demonstrate, to a client, the various coverage opportunities at play. The manual mud map generation process is intensive, time-consuming, and prone to human error. Conversely, the complex quote structure generation produced using the methods and systems described herein automatically arranges the various options to form, like pieces of the puzzles, combination of quote offers (e.g., various products and layers of coverage) that fulfill a client's risk coverage requirements. Thus, the complex quote structure generation provides a technical solution not available at the time of filing the present disclosure to visualizing quote options in a consistent and trustworthy fashion.

In some embodiments, the complex quote structure includes a mud map representing stacked options that, in combination, may be used to fulfill a desired risk capacity. The options may be arranged and/or qualified (e.g., ranked, color-coded, etc.) to identify preferred or recommended options.

The foregoing general description of the illustrative embodiments and the following detailed description thereof provide mere examples of various aspects of the teachings of this disclosure and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. In the drawings:

FIG. 1 is a block diagram of an example system for extracting, analyzing, and applying transactional information obtained from a collection of unstructured and/or semi-structured documents;

FIG. 2A and FIG. 2B illustrate a flow diagram of an example process for extracting and organizing transactional attributes from unstructured and/or semi-structured documents;

FIG. 3 is a flow chart of an example method for analyzing email documents to classify transactional information contained therein;

FIG. 4 is a flow chart of an example method for converting transactional information culled from document contents into semantically linked transactional relationships;

FIG. 5 is an example quote comparison graphical user interface; and

FIG. 6 is a flow diagram of an example process for qualifying semantically linked transactional information and applying the qualified transactional information in generating transactional visualizations;

FIG. 7 is an example graphical user interface for enabling end user confirmation and/or adjustment of semantically linked transactional information; and

FIG. 8 is an example insurance coverage structure graphical user interface.

### DETAILED DESCRIPTION OF ILLUSTRATIVE EMBODIMENTS

The description set forth below in connection with the coordinating drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

As used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more. ” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Further, the terms “approximately,” “about,” “proximate,” “minor variation,” and similar terms generally refer to ranges that include the identified value within some margin, such as, in some examples, 20%, 10%, or 5% in certain embodiments, as well as any values therebetween.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that the inventors intend that that feature or function may be deployed, utilized or implemented in connection with the alternative embodiment unless the feature or function is incompatible with the alternative embodiment.

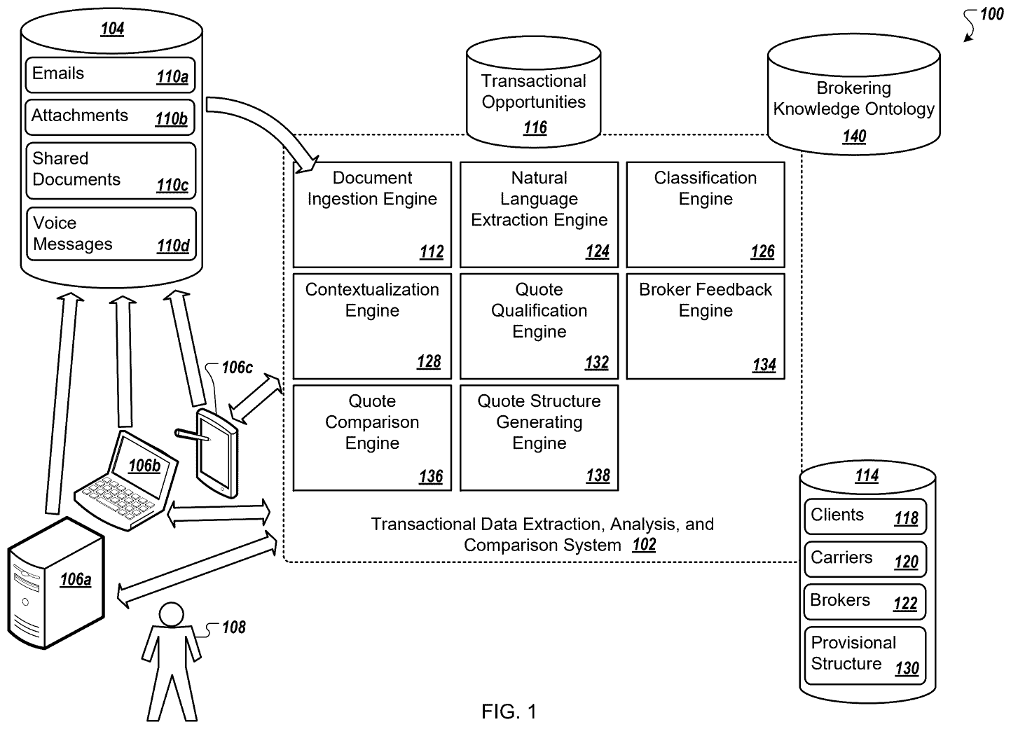

FIG. 1 is a block diagram of an example system 102 and architecture 100 for extracting, analyzing, and applying transactional information obtained from a collection 104 of unstructured and/or semi-structured documents 110 gathered from a variety of computing devices 106 used by brokers, such as a broker 108, communicating with carriers (e.g., insurance and/or reinsurance carriers) on behalf of clients. The documents 110, in some examples, may include emails 110a, email attachments 110b, shared documents 110c (e.g., exchanged via a platform, file transfer service, etc.), and/or digital recordings of voice messages 110d. At least a portion of the documents 110, in some embodiments, are automatically gathered from each of the computing devices 106 (e.g., a server 106a, portable computer 106b, and/or personal computing device 106c, etc.). In some embodiments, at least a portion of the documents 110 are transferred to the collection 104 (e.g., data storage region accessible to the system 102) upon request or instruction by the broker 108 (e.g., drag and dropped or otherwise shared with the system 102). In an illustrative example used throughout, the transactional information may be related to gathering quotes for fulfilling a layered coverage structure associated with a risk fulfillment transaction. In other embodiments, the transactional information may relate to later aspects of the brokering process, such as transactional agreements during a bind stage or application of a claim against a purchased coverage structure.

The various engines (e.g., processing units) of the system 102, in some embodiments, are configured as software routines or processes (e.g., at least a portion of a software program) coded as instructions (e.g., software code) for executing on processing circuitry, such as one or more processors. Certain engines or operations performed by certain engines, in some embodiments, are configured as hardware logic (e.g., hardware-based operations) hard-coded or programmed into processing circuitry (e.g., logic circuitry), such as, in some examples, a programmable logic chip or other programmable logic device, an application-specific integrated circuit (ASIC), or a customized processor device. In an illustrative example, a software routine or process component of one of the engines may provide data and/or variable values (e.g., within a non-transitory computer-readable medium) for use by hardware logic of that engine.

A document ingestion engine 112 of the system 102, in some implementations, performs an initial ingestion of each of the documents 110 in the document collection 104.

The document ingestion engine 112, for example, may perform an initial mapping of transactional information (e.g., quote-related information) for storage to a transactional opportunities data store 116. For example, email recipients, document title, or other document naming convention may be used to identify a corresponding carrier of a set of carriers 120 captured in a business data store 114. Further, a source of the documents 110 (e.g., the broker 108) may be used to identify the corresponding broker 108 of a set of brokers 122. A document title, subject line of an email, or other information, in another example, may specify a particular client 118 and/or a provisional structure 130 representing the client risk profile and architecture (e.g., designed by the broker 108) representing a layered coverage structure for covering risk for a particular client. The document ingestion engine 112, further, may obtain a portion of the information from metadata associated with certain documents 110, such as document metadata identifying the document's creator or email metadata identifying the recipient. The document ingestion engine 112 may organize the extracted information in the transactional opportunities data store 116.

In some implementations, the document ingestion engine 112 extracts text content from at least a portion of the documents 110. If certain documents are in a semi-structured form (e.g., a spreadsheet layout having a known format based on a particular carrier 120), in some embodiments, the document ingestion engine 112 extracts text content in correspondence to known classifications of portions of the text. If certain documents are not yet in text form (e.g., PDF documents, graphic documents, etc.), in some embodiments, the document ingestion engine 112 performs optical character recognition (OCR) to recognize text content in those documents. Due to the uncertainty in recognizing characters by OCR, the document ingestion engine 112 may store metadata related to the extracted text regarding a confidence in the OCR performance.

The document ingestion engine 112, in some implementations, converts each document to a standardized format. The format, for example, may be a plain text format.

In some implementations, the document ingestion engine 112 provides each document 110 to a natural language extraction engine 124 for recognizing meaningful information in each of the documents 110. For example, text-based natural language processing (NLP) may be applied to the body text of emails 110a, attachments 110b, and/or shared documents 110c to identify quote-related information, while vocalization-based NLP may be applied to the voice messages 110d. For example, NLP may be used to remove extraneous content such as signatures and greetings, while formatting the remaining content for further processing.

In some implementations, a classification engine 126 applies transactional knowledge and/or business rules to organizing aspects of the document content. The classification engine 126, for example, may arrange the content supplied by the natural language extraction engine 124 into quote aspects (e.g., coverage, limit, etc.). Each quote aspect identified within the document content, for example, may be tagged with a classification according to a classification schema (e.g., aspect of a quote, such as a coverage value, a limit, capacity, attachment point, etc.). The classification engine 126, in some embodiments, applies one or more machine learning models in tagging document content according to classification. The classification schema, for example, may be part of a brokering knowledge ontology 140. The tagged document content may be stored to the transactional opportunities data store. The quote classification schema, in illustration, may translate various terminology and phrasing used by insurance carriers around the world into a consistent, standardized terminology that lends to a later apples-to-apples analysis.

In some embodiments, the tagged information is shared with the broker 108 to confirm the tags have been applied correctly and/or the values related to each tag (e.g., limit, attachment point, quoted amount, etc.) have been captured correctly. In some implementations, the tagged and linked information is presented to the broker 108 via a broker feedback engine 134 for review. The broker feedback engine 134, for example, may prepare an interactive graphical user interface for presentation to the broker 108, allowing the broker 108 to amend or remove information automatically derived by the system 102 from the documents 104. Through the interactive graphical user interface presented at one of the computing devices 106, for example, the broker 108 may correct any mistakes within the automatically tagged aspects and/or delete certain tagged aspects, thereby removing those aspects from future processing.

In some implementations, a contextualization engine 128 creates semantic based groupings of the tagged document content. The contextualization engine 128, for example, may logically link multiple aspects of a given layer of quoted coverage derived from document content including multiple quoted options for a single coverage layer and/or multiple quoted layers of coverage. The contextualization engine 128, for example, may apply the logical links within the transactional opportunities data store 116, linking stored aspects together. The contextualization engine 128, for example, may identify relationships between information provided in multiple documents, such as an email body and its attachment(s) or a series of emails (e.g., an initial quote offer and an updated quote offer), thereby compiling a full picture of the quote offer of each insurance carrier from electronic documents that may have been transmitted in various formats at various times throughout the course of a series of days.

The contextualization engine 128, in some embodiments, semantically groups the tagged document content according to attributes, entities, and rules captured within the brokering knowledge ontology 140. The brokering knowledge ontology 140, for example, may include aspects of a business glossary defining and/or describing a set of business terms as well as business rules defining relationships between elements of the business glossary (e.g., business terms tagged within the tagged document content). The brokering knowledge ontology 140, for example, may be stored as a resource description framework (RDF).

In some embodiments, the contextualization engine 128 converts information stored in the transactional opportunities data store 116 into a logically linked graph, framework, or neural network of information. The information, in some embodiments, may be stored in a vector form for later analysis using artificial intelligence, as described in greater detail below.

The logically linked graph, framework, or neural network of information, for example, may contain links useful in identifying all quote offers related to a particular risk fulfillment request associated with a particular client. Further, the logically linked graph, framework, or neural network of information may contain links useful in identifying all aspects (e.g., layers, products, etc.) related to quote offers of a particular insurance carrier that responded to the risk fulfillment request. In an additional example, the logically linked graph, framework, or neural network of information may contain links useful in identifying all quote offers (e.g., layers, products, etc.) from all insurance carriers relevant to a particular aspect of the risk fulfillment request (e.g., cybersecurity coverage needs in a particular geographic region, catastrophic event coverage needs in a particular geographic region, etc.). In yet another example, the logically linked graph, framework, or neural network of information may contain links useful in matching quote offers to standard information (e.g., terms and conditions, reputation, etc.) related to each insurance carrier that submitted a quote offer responsive to the risk fulfillment request.

In some implementations, logically linked aspects of the document content are analyzed by a quote qualification engine 132 to match the received information to the provisional structure 130. For example, if a quote received from a carrier fails to match the parameters requested by the broker 108, the quote qualification engine 132 may flag the quote as being unresponsive to the client's initial query.

If the quote qualification engine 132 determines that a quote does not align with the parameters of the provisional structure 130, in some implementations, the tagged and linked information is presented to the broker 108 via the broker feedback engine 134 for review.

The broker feedback engine 134, for example, may prepare an interactive graphical user interface for presentation to the broker 108, allowing the broker 108 to amend relationships within or remove information from linked document content. Through the interactive graphical user interface presented at one of the computing devices 106, for example, the broker 108 may correct any mistakes within the automatically tagged and linked transactional aspects and/or delete the particular quote, thereby removing it from future processing.

In some implementations, after the quote information has been translated by the system 102 into the transactional opportunities 116, the quote qualification engine 132 objectively evaluates the merits of each quote provided in the documents 104. The quote qualification engine, for example, may collect all transactional information related to a given provisional structure 130 from the transactional opportunities 116 and analyze the transactional opportunities 116 in view of the given provisional structure 130 to determine relative responsiveness of each quote to fulfilling an aspect (e.g., coverage layer) of the provisional structure 130. The quote qualification engine 132, in some embodiments, applies the knowledge base of the brokering knowledge ontology 140 to rate or rank various interchangeable options provided in the carrier quotes. The brokering knowledge ontology, for example, may include rules or other evaluation metric calculations that can be used by the quote qualification engine 132 to weigh quotes based on benefits and/or negatives associated with the various risk fulfillment options. The quote qualification engine 132, in some embodiments, evaluates the quotes on a variety of bases such as, in some examples, a general financial assessment, a limits of liability assessment, a deductible assessment, and/or a terms & conditions assessment. The quote qualification engine 132 may classify, rank, and/or rate each quote option based on a collection of criteria (e.g., financial match, limits of liability, deductible, and/or terms & conditions, etc.). The quote qualification engine 132 may add evaluation data and/or metrics to the transactional opportunities 116.

In some implementations, a quote comparison engine 136 obtains the evaluation information produced by the quote qualification engine 132 and prepares comprehensive assessments between quoted risk fulfillment options to fulfill the provisional structure 130 corresponding to a particular client's risk coverage needs. The quote comparison engine 136, for example, may create a human-readable comparison output (e.g., spreadsheet, tabular and/or graphical report, interactive graphical user interface, etc.) for review by the broker 108. The human-readable comparison output, in an illustrative example, may be provided in the form of a “mud map” that color codes the various carrier offerings in a manner that conveys relative strengths and weaknesses of the various quotes.

In some implementations, a quote structure generating engine 138 obtains the evaluation information produced by the quote qualification engine 132 and prepares a graphical representation of an insurance coverage structure representing quotes offered by one or more carriers within the documents 104. The insurance coverage structure, for example, may conform to the provisional structure 130. The graphical representation may be provided in a report or interactive graphical user interface for review by the broker 108.

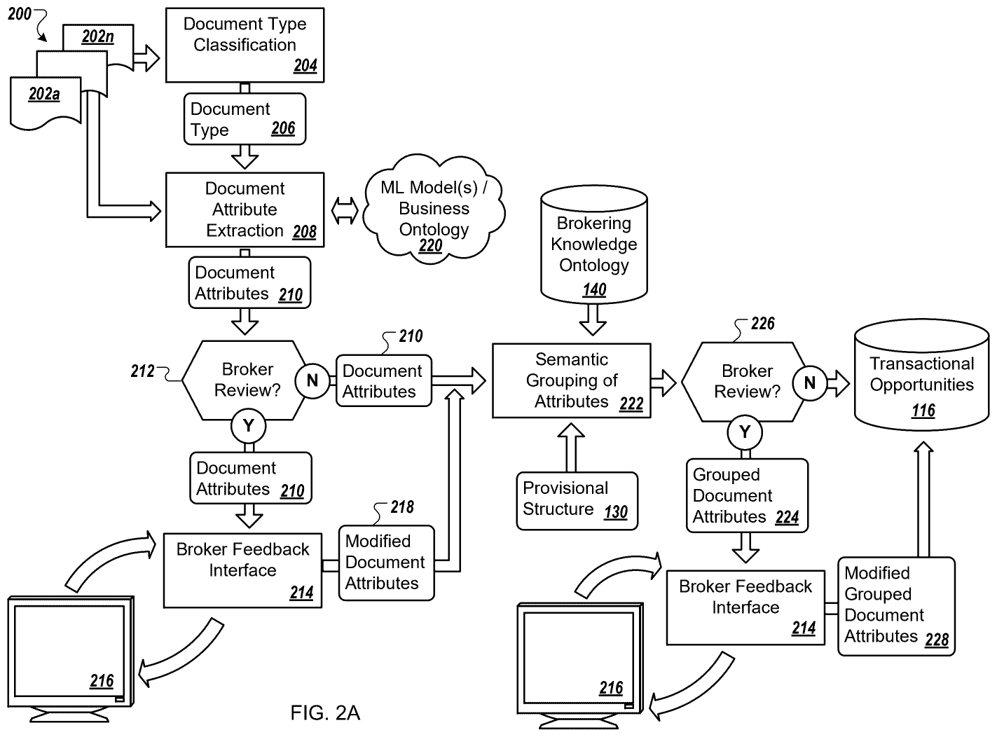

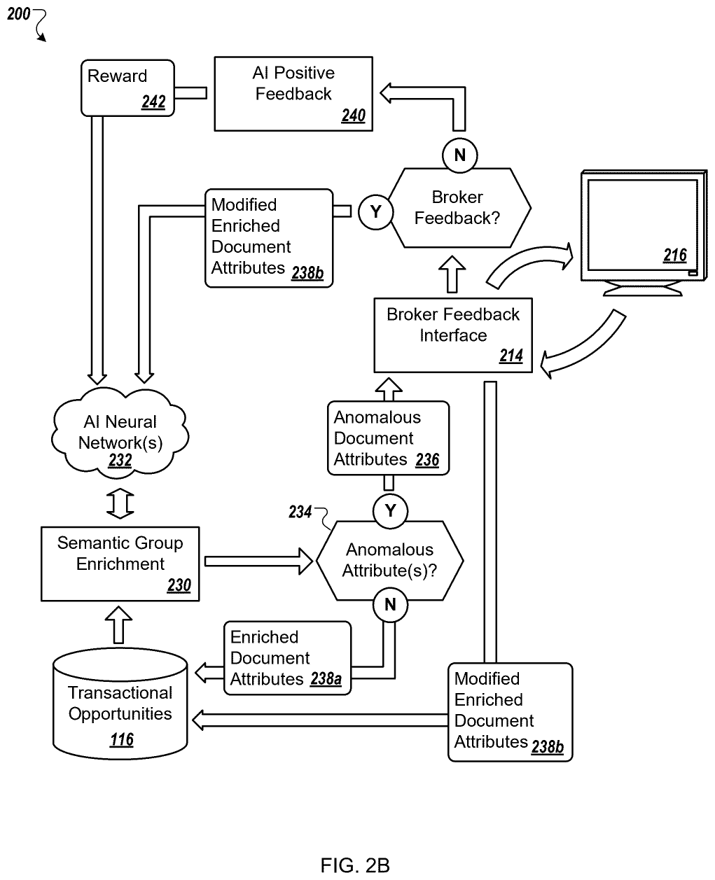

FIG. 2A and FIG. 2B illustrate a flow diagram of an example process 200 for extracting and organizing transactional attributes from unstructured and/or semi-structured documents is presented. The process 200, for example, may be performed by the transactional data extraction, analysis, and comparison system 102 of FIG. 1.

The various processing units (e.g., engines) of the process 200, in some embodiments, are configured as software routines or processes (e.g., at least a portion of a software program) coded as instructions (e.g., software code) for executing on processing circuitry, such as one or more processors. Certain processing units or operations performed by certain processing units, in some embodiments, are configured as hardware logic (e.g., hardware-based operations) hard-coded or programmed into processing circuitry (e.g., logic circuitry), such as, in some examples, a programmable logic chip or other programmable logic device, an application-specific integrated circuit (ASIC), or a customized processor device. In an illustrative example, a software routine or process component of one of the processing units may provide data and/or variable values (e.g., within a non-transitory computer-readable medium) for use by hardware logic of that processing unit.

Turning to FIG. 2A, in some implementations, the process 200 begins with accessing, at a document type classification unit 204, one or more documents 202. The documents 202, for example, may include the email(s) 110a, the attachment(s) 110b, the shared document(s) 110c, and/or the voice message(s) 110d described in relation to FIG. 1. The document type classification unit 204, for example, may receive the one or more documents 202 via an application programming interface (API), retrieve the one or more documents 202 from a non-transitory computer-readable data store, or request the one or more documents 202 from a communication service (e.g., email service, broker-carrier communication portal, etc.). The documents, in one example, may have been ingested by the document ingestion engine 112 and/or formatted by the natural language extraction engine 124 of FIG. 1.

In some implementations, the document type classification unit 204 analyzes each document 202 to identify a document type 206 associated with each document 202. The possible document types, in some examples, can include a relevant type (e.g., transaction-related) versus an irrelevant type (e.g., not containing transaction information). In another example, the potential document types may include a type of transaction (e.g., a quote transaction, a bind transaction, a claim transaction, etc.). In the example of email documents 202, the document type classification unit 204 may recognize a transaction identifier in a subject line of the email, a party to the message in email metadata (e.g., a known (re)insurance carrier as the sender), and/or a client identifier in the subject line and/or email metadata (e.g., name or customer identifier of the organization seeking risk coverage). In relation to shared documents (e.g., text, image, and/or PDF files, etc.), in another example, the document name, document metadata, and/or document storage location (e.g., if pulled from a storage system having dedicated storage regions per identifier) may be used to recognize a transaction identifier, (re)insurance carrier identifier, client identifier, and/or document type. If the document type classification unit 204 obtains identifying information for a transaction, (re)insurance carrier, and/or client, in some embodiments, the document type classification unit 204 cross-references the identifying information with transactions to identify a document type 206 (e.g., transaction type).

In some implementations, when the document type classification unit 204 identifies a relevant document type (e.g., transaction type) the document type classification unit 204 provides the document type 206 to a document attribute extraction unit 208. The document attribute extraction unit 208 additionally obtains (e.g., from the document type classification unit 204 or through independent access) the corresponding document 202 to the document type 206.

The document attribute extraction unit 208, in some implementations, is configured to recognize, within text content of the document 202, a set of document attributes 210 related to at least one transaction, such as at least one quote offer from a (re)insurance carrier. The document attribute extraction unit 208, for example, may perform a portion of the operations described in relation to the classification engine 126 of FIG. 1. The document attributes 210, in some examples, may each represent an aspect of a business ontology 220 related to the document type (e.g., quote, bind, etc.). In illustration, in relation to a (re)insurance quote, the applicable business ontology 220 may include the following attributes: one or more limits, a brokerage rate, a margin, a coverage value, an offer expiration, a capacity, an attachment point, and/or terms and conditions. Further, the business ontology 220 may include party identification (e.g., a carrier, a client, a broker, etc.). Using the business ontology 220, the document attribute extraction unit 208 may identify values related to each of a set of attributes presented in the document. The document attributes 210, in some examples, may be identified using optical character recognition (OCR), natural language processing (NLP), machine learning analysis, and/or neural network (e.g., artificial intelligence, foundational model, large language model, etc.) analysis. Upon identifying values associated with each attribute, for example, the document attribute extraction unit 208 may label each attribute in accordance with the business ontology 220 and collect as the document attributes 210. In illustration, a value of “Acme Underwriting Company” may be labeled with a value representing “insurance carrier.” The document attributes 210 may be stored to a temporary storage region or non-transitory computer readable storage medium by the document attribute extraction unit 208 for further processing.

In some embodiments, the document attribute extraction unit 208 applies one or more machine learning models 220 configured to recognize terms according to a given business ontology (e.g., a quote offers ontology, a bind ontology, a claims ontology, etc.) and label those terms accordingly. Each machine learning model 220, for example, may be trained using a corpus of documents including information pertaining to transactions. The documents may be truth labeled according to the relevant business ontology. In some examples, each given machine learning model 220 may be configured using one or more Bayesian machine learning classifiers, such as random forest classifiers and/or k-nearest neighbor classifiers, to provide confidence-based identification and labeling of the document attributes 210. The machine learning models 220, for example, may be trained to flag certain attributes for user review based upon a confidence level failing to reach a threshold level of confidence. Based upon feedback provided by an end user, for example, the training of the ML model(s) 220 may be updated to ensure accurate and consistent labeling.

If broker review is desired (212) in some embodiments, the document attribute extraction unit 208, after extracting the document attributes 210, provides the document attributes 210 to a broker feedback interface unit 214 for presenting the document attributes 210 on a display 216 for review by a remote user (e.g., via a graphical user interface presented via a remote computing device) to allow the remote user to approve and/or update the values and/or labeling of the document attributes 210. The broker feedback interface unit 214, for example, may perform a portion of the operations of the broker feedback engine 134 of FIG. 1. If one or more of the values and/or labels of the document attributes 210 are adjusted by an end user via the user interface generated by the broker feedback interface unit 214, in some embodiments, modified document attributes 218 are produced.

The document attribute extraction unit 208, in some implementations, converts the values of the document attributes 210 and/or the modified document attributes 218 into vector format. The attribute values, for example, may each be converted to a numeric format arranged in a high-dimensional vector form. The high-dimensional vector form, for example, may be associated with its corresponding attribute tag or label.

In some implementations, the document attributes 210 or, if applicable, the modified document attributes 218, are used by a semantic grouping of attributes unit 222 to define relationships between the document attributes 210/modified document attributes 218. The semantic grouping of attributes unit 222, for example, may perform similar operations to those described in relation to the contextualization engine 128 of FIG. 1.

In some embodiments, the semantic grouping of attributes unit 222 generates semantic links between related document attributes 210, 218 in art according to the risk coverage architecture being fulfilled on behalf of a client (e.g., the provisional structure 130). The semantic groupings, in some examples, may capture exposure aspects corresponding to a number of layers of risk coverage according to the provisional structure 130. The semantic grouping of attributes unit 222, for example, may align related document attributes according to the provisional structure 130, and compare related document attributes 210 to a corresponding requirement in the provisional structure 130 to identify whether the quote offer meets the qualifications of the client's risk coverage needs.

The semantic grouping of attributes unit 222, in certain embodiments, generates semantic links according to a taxonomy of transactional information related to the document type 206 (e.g., a portion of the brokering knowledge ontology 140). The taxonomy may include aspects related to various geographies, business lines, and/or risk categories.

The semantic grouping of attributes unit 222, in some implementations, arranges, or clusters, the vector forms of the grouped document attributes 224 into semantic relationships linked within a vector data store, such as a knowledge graph (e.g., graph neural network). The knowledge graph, for example, may be stored as the transactional opportunities 116. The grouped document attributes 224 are linked, within the knowledge graph, as semantically grouped subsets of the document attributes 224 according to identified relationships.

If broker review is desired (226) in some embodiments, the semantic grouping of attributes unit 222, after semantically organizing the document attributes 210, 218 as the grouped document attributes 224, provides the grouped document attributes 224 to the broker feedback interface unit 214 for presenting the document attributes 210 on a display 216 for review by a remote user (e.g., via a graphical user interface presented via a remote computing device) to allow the remote user to approve and/or update the correspondences and/or relationships captured in the grouped document attributes 224. The broker feedback interface unit 214, in another example, may be provided the opportunity to update attribute values and/or tags or labels, as described in relation to review of the document attributes 210, above. For example, rather than two separate review cycles, broker feedback may be requested at a single time. In another example, broker feedback may only be pursued in relation to document attribute extraction in the circumstance where the document attribute extraction unit 208 identifies a desire for review (e.g., lower than a threshold confidence in portions of the tagged/labeled attributes), while the second feedback request may provide the end user to update any information. If one or more of the values and/or labels of the document attributes and/or the relationships defined through the linking of the grouped document attributes 224 are adjusted by an end user via the user interface generated by the broker feedback interface unit 214, in some embodiments, modified grouped document attributes 228 are produced. The modified grouped document attributes 228 may be stored to the transactional opportunities 116 as described above.

Turning to FIG. 2B, in some implementations, a semantic group enrichment unit 230 enriches the grouped document attributes 224 within the transactional opportunities 116 with relevant business knowledge. At least one artificial intelligence (AI) neural network 232 trained or fine-tuned with business knowledge related to at least a segment of the document type 206 (e.g., the transaction type as well as, potentially, a particular product, business line, and/or geographical region, etc.), for example, may enrich certain grouped document attributes with richer contextual information. The enrichments, for example, may include deriving relationships between attributes, such as parent-child relationships (e.g., layers of deductibles). In another example, the enrichments may include analyzing in view of rules and/or amending (e.g., logically linking) to incorporate rules with certain attributes, such as exclusions to values based on contextual relationships. In some examples, the exclusions may be based on factors such as distance, number of occurrences, and/or geographic location. The enrichments, further, may include cross-referencing information to double check for accuracy and/or conformance with transactional boundaries. In a first example, based on contextual cues within the document (e.g., in view of the document type 206), the semantic group enrichment unit 230 may validate the value of one or more attributes in view of a standard (e.g., a set of thresholds and/or ranges). The document attributes, further, may be logically mapped to the standard. The thresholds and/or ranges, in illustration, may be derived at least in part from the provisional structure 130 described in relation to FIG. 1. In a second example, the semantic group enrichment unit 230 may perform a historic review of the unstructured and/or semi-structured documents 110 of FIG. 1 in view of the document attributes 224 to confirm that the values of the document attributes 224 align with values accepted throughout the transactional history captured within the unstructured and/or semi-structured documents 110.

If the semantic group enrichment unit 230 detects one or more anomalies while cross-referencing and/or otherwise double-checking attribute values (234), in some implementations, the semantic group enrichment unit 230 prepares one or more anomalous document attributes 236 for presentation on the display 216 for review by a remote user to allow the remote user to approve and/or update the anomalous document attributes 236. Although illustrated in relation to the anomalous document attributes 236 alone, in certain embodiments, the enriched document attributes 238a may be presented for broker feedback whether or not any anomalous document attributes 236 have been identified. If one or more of the values, labels, and/or relational links among the anomalous document attributes 236 (and/or the enriched document attributes 238a) are adjusted by an end user via the user interface generated by the broker feedback interface unit 214, in some embodiments, modified enriched document attributes 238n are produced. Modified enriched document attributes 238b may be stored to the transactional opportunities data store 116 along with the enriched document attributes 238a that were not subject to modification.

In some implementations, if the remote user applies one or more adjustments to the information presented regarding the enriched document attributes 238a, the modified enriched document attributes 238b are provided as learning feedback to the AI neural network(s) 232.

Further, if the remote user accepts one or more anomalous document attributes 236 and/or enriched document attributes 238a without modification, in some implementations, information regarding the accepted enriched document attributes is provided to an artificial intelligence (AI) positive feedback unit 240 for generating reward feedback 242 provided to the AI neural network(s) 232 to reinforce the neural network functionality based on accurate performance. The reward feedback 242, for example, may include a score representing a correctness of information or acceptability of information. The feedback score may be commensurate with a size and/or scope of the enriched document attributes 238a and/or anomalous document attributes 236.

Although illustrated as a particular flow of operations, in other embodiments, the process 200 may include more or fewer operations. For example, if certain document attributes 210 produced by the document attribute extraction unit 208 of FIG. 1 are modified via the broker feedback interface unit 214 (e.g., as modified document attributes 218), the modified document attributes 218 may be provided as training data to update at least one ML model of the ML model(s) 220. In a second example, rather than presenting information for broker review of the grouped document attributes 224, the document attributes may first be enriched by the semantic group enrichment unit 230. In further embodiments, certain operations of the process 200 may be performed concurrently and/or in a different order. Other modifications of the process 200 are possible.

Although described in relation to a flow of operations involving a particular set of processing units, in other embodiments, the process 200 may include more or fewer processing units. For example, the process 200 may include an optical character recognition unit to assist in document attribute extraction and/or a vector indexing unit for storing the grouped document attributes 224 to the transactional opportunities data store 116. In certain embodiments, the process 200 may include more or fewer operations. For example, if certain document attributes 210 produced by the document attribute extraction unit 208 of FIG. 1 are modified via the broker feedback interface unit 214 (e.g., as modified document attributes 218), the modified document attributes 218 may be provided as training data to update at least one ML model of the ML model(s) 220. Further, although described in relation to a particular flow of operations, in other embodiments, certain aspects of the process 200 may be performed in a different order. For example, the grouped document attributes 224 may be provided for user feedback via the broker feedback interface unit 214 after the semantic groups of attributes have been enriched by the semantic group enrichment unit 230. Other modifications of the process 200 are possible.

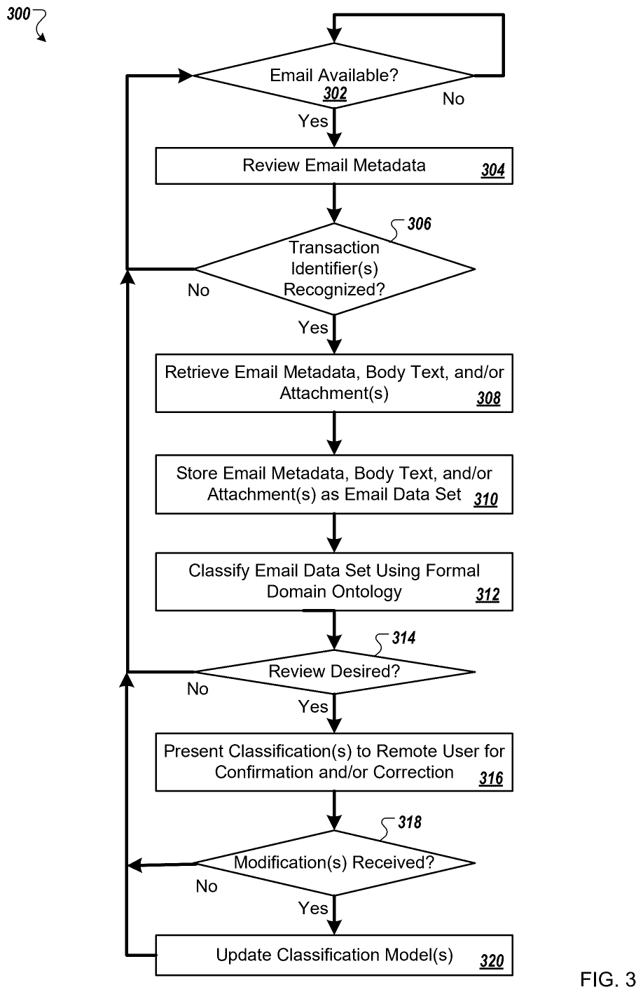

FIG. 3 illustrates a flow chart of an example method 300 for analyzing email documents to classify transactional information contained therein. Portions of the method 300, for example, may be performed by the transactional data extraction, analysis, and comparison system 102 of FIG. 1. The method 300, for example, may perform a portion of the operations executed by the process 200 of FIG. 2A and FIG. 2B.

In some implementations, the method 300 begins with identifying availability of an email (302). A widget, bot, or extension to an email program, in one example, may be configured to recognize receipt of emails for automatic review. In another example, an email may be flagged (e.g., shifted to a special folder, tagged with a dedicated marker within the email application) by a broker via a personal computing device. The email may be one of the emails 110a of FIG. 1.

In some implementations, the email metadata is reviewed (304). Metadata such as, in some examples, a sender identifier (e.g., name, email address, etc.), a recipient identifier, a subject line, a timestamp, and/or a description may be retrieved from the email document. The subject line, for example, may be reviewed for a transaction identifier related to a particular transaction (e.g., quote request). In another example, other metadata, such as the sender identifier and/or the description, may be matched to a transaction identifier. In illustration, a particular carrier as the sender and a particular client identified in the subject line may point to a particular transaction. The email, for example, may be reviewed to recognize at least the document type 206 as described in relation to the document type classification unit 204 of FIG. 2A and FIG. 2B.

In some implementations, if one or more transaction identifiers are recognized from the email metadata (306), the email metadata, body text, and/or attachments are retrieved (308). The information, for example, may be retrieved for ingestion by the document ingestion engine 112 of FIG. 1.

In some implementations, the email metadata, body text, and/or attachments are stored as an email data set (310). The document ingestion engine 112 of FIG. 1, for example, may create a local copy of at least a portion of the email for analysis by further engines of the system 102. The storage, for example, may be a temporary binary large object (blob) storage for holding unstructured data pending processing.

In some implementations, the email data set is classified using a formal domain ontology (312). The contents of the email data set, for example, may be classified as described in relation to the classification engine 126 of FIG. 1. The formal domain ontology may be part of the brokering knowledge ontology 140 of FIG. 1. The classification process, for example, may include a portion of the process 200 of FIG. 2A and FIG. 2B such as, in some examples, operations described in relation to the document attribute extraction unit (208). In some embodiments, classification involves providing formatted portions of the email data set to at least one trained machine learning classifier and/or artificial intelligence network (e.g., the ML model(s) 220 of FIG. 2A) for performing unsupervised learning techniques in classifying the contents of the portion(s) of the email data set. The machine learning classifier(s) and/or artificial intelligence network(s), for example, may be configured to recognize attributes within the portion(s) of the email data set according to the formal domain ontology (e.g., the brokering knowledge ontology 140 of FIG. 1 and/or the business ontology 220 of FIG. 2A). The formal domain ontology, for example, may be a (re)insurance brokering-specific ontology including terminology, relationships, and business rules related to a particular (re)insurance transaction topic. The (re)insurance transaction topics, in some examples, may include property insurance, casualty insurance, and/or cyber security insurance. The (re)insurance transaction topics may include various lines of business such as, in some examples, construction, transportation, power & energy, and/or global professions. In some embodiments, the (re)insurance transaction topics include geographic-specific brokering ontology (e.g., North America, Europe, EMEA (Europe, the Middle East, and Africa), Asia-Pacific (APAC), etc.).

In some implementations, if a review is desired (314), at least one of the classifications is presented to a remote user for confirmation and/or correction (316). Review may be deemed to be desired, for example, based on the at least one trained machine learning classifier and/or artificial intelligence network determining a lack of threshold confidence associated with the classifying of at least one attribute of the email data set. For example, as described in relation to the broker feedback interface unit 214 of FIG. 2A, document attributes 210 may be presented for review by a remote user.

If one or more modifications are received (318) responsive to presenting the classification(s) to the remote user, in some implementations, at least one classification model is updated (320). One or more new attributes and/or entities, for example, may be added to the trained machine learning classifier(s) and/or artificial intelligence network(s) based on the feedback received from the remote user. In another example, one or more rules may be modified or added based on the feedback received from the remote user. The updates regarding the rule(s), attribute(s), and/or entity(ies), for example, may be applied to the formal domain ontology.

Although described in relation to a particular set of operations, in other embodiments, the method 300 may include more or fewer operations. For example, the method 300 may include formatting operations, such as natural language processing and/or optical character recognition, to formation portions of the email data set in preparation for classifying (312). Further, although described as a particular series of operations, in other embodiments, certain operations of the method 300 may be performed in a different order and/or concurrently. For example, the email metadata may be reviewed (304) after retrieving (308). Other modifications of the method 300 are possible.

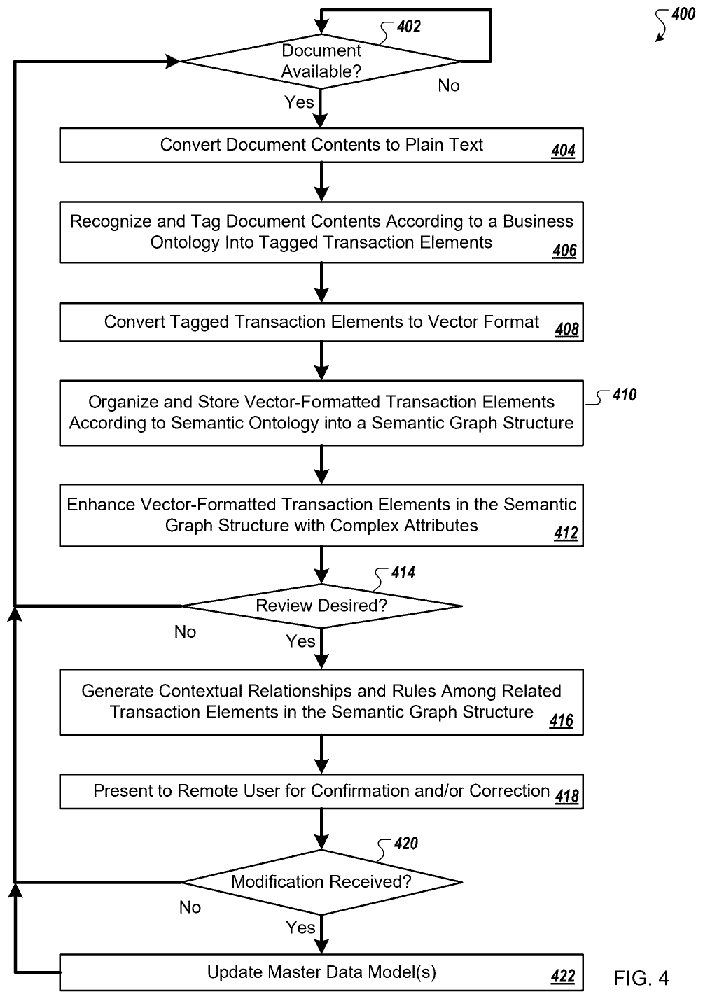

FIG. 4 is a flow chart of an example method 400 for converting transactional information culled from document contents into semantically linked transactional relationships. Portions of the method 400, for example, may be performed by the transactional data extraction, analysis, and comparison system 102 of FIG. 1. The method 400, for example, may perform a portion of the operations executed by the process 200 of FIG. 2A and FIG. 2B.

In some implementations, the method 400 begins with determining whether a document is available (402). A widget, bot, or extension to an email program, in one example, may be configured to recognize receipt of emails for automatic review and pull any document attachments from the email. In another example, a document may be flagged (e.g., shifted to a special folder, tagged with a dedicated marker within the email application) by a broker via a personal computing device. The document, in illustration, may be dragged and dropped into a file transfer protocol (FTP) folder for document upload to a remote system, such as the system 102 of FIG. 1. The document may be one of the attachments 110b or shared documents 110c of FIG. 1.

When a document is available for processing (402), in some implementations, the contents of the document may be converted to plain text (404). Optical character recognition, in one example, may be performed on the document to recognize text within. A Microsoft Word document, in another example, may be converted from docx format to a plain text format. The document ingestion engine 112 and/or the natural language extraction engine 124 of FIG. 1, for example, may process the document to convert it to plain text.

In some implementations, the document contents are recognized according to a business ontology and tagged into tagged transaction elements (406). The business ontology may be the brokering knowledge ontology 140 of FIG. 1. The document contents may be recognized and tagged, for example, by the classification engine 126 of FIG. 1. The document may be tagged, in another example, as described in relation to the document attribute extraction unit 208 of FIG. 2A. Each tagged transaction element, for example, may include a word or phrase corresponding to a concept captured in the business ontology.

In some implementations, the tagged transaction elements are converted to vector format (408). The document attribute extraction unit 208 of FIG. 2A, for example, may convert the tagged transaction elements to vector format. The vector format, for example, may capture the semantic meaning of the tagged word of phrase of each transaction element in a manner consistent with the business ontology.

In some implementations, the vector-formatted transaction elements are organized and stored according to a semantic ontology into a semantic graph structure (410). The semantic grouping of attributes unit 222 of FIG. 2A, for example, may organize the vector-formatted transaction elements into a semantic graph (e.g., as stored in the transactional opportunities data store 116). The semantic ontology, for example, may include a brokering ontology specific to the document type (e.g., document type 206 of FIG. 2A). The semantic ontology may include rules, relationships, and hierarchies of information related to at least one type of insurance quote (e.g., insurance quote information), in an illustrative example. The semantic ontology may further include information useful in linking entities of the transactional information, such as clients 118, carriers 120, and/or brokers 122, as described in relation to FIG. 1. Organizing the vector-formatted transaction elements may include linking related transaction elements that have a semantic association into a chain of dependencies (e.g., classes, properties, and/or entity types). In another example, organizing the vector-formatted transaction elements may include arranging hierarchically related transaction elements or linked chains thereof in a hierarchical structure (e.g., a tree-based structure). The semantic graph, for example, may be a rule-based semantic graph arranged in a manner that comports with business rules of the semantic ontology.

In some implementations, the vector-formatted transaction elements in the semantic graph structure are enhanced with complex attributes (412). The enhancement, for example, may be performed by the semantic group enrichment unit 230 of FIG. 2B. Additional relationships, correspondences, and/or rules governing the organization of the vector-formatted transaction elements within the semantic graph, for example, may be formed by analyzing the semantic graph in view of a preexisting knowledge base. One or more machine learning models and/or artificial intelligence networks, for example, may be trained to recognize relationships and enhance the semantic graph according to the business knowledge trained or fine-tuned into the machine learning model(s) and/or AI network(s). Enhancing the semantic graph, in some examples, may include capturing the recognized relationships in corresponding logical connections, importing characteristics to transaction elements from one or more similar transaction elements determined to be related to the transaction element, and/or adding characteristics (attributes) to transaction elements according to the business knowledge (e.g., a business ontology). The AI neural network(s) 232 of FIG. 2B, for example, may analyze the semantic graph to enhance its contents with complex attributes. The attributes, in some examples, can include identification and/or description of quote layers, quote limits, coverage details, etc. In some embodiments, the attributes include relational links between the transaction elements of the document and pre-existing transaction elements previously stored in relation to other documents (e.g., other documents related to the same transaction and/or to similar transactions). In an illustrative example, a quote layer defined in the current document may be aligned appropriately with neighboring layers that may have been quoted in separate documents.

In some implementations, if a review is desired (414), contextual relationships and rules among the related transaction elements in the semantic graph are generated (416). The contextual relationships and rules, for example, may be derived from the linking structure applied during organization and storage of the vector-formatted transaction elements. Certain contextual relationships and rules, in another example, may be derived from the complex attributes added as enhancements to the vector-formatted transaction elements. The contextual rules and relationships, for example, may be generated in a manner that enables presentation for human review. For example, the broker feedback interface unit of FIG. 2B and/or another processing unit (not illustrated) in communication with the broker feedback interface unit may generate the contextual rules and relationships to visually represent the anomalous document attributes 236 and/or the enriched document attributes 238a. The contextual rules and relationships, in some embodiments, are generated at least in part using one or more machine learning models. The machine learning models, for example, may be trained at least in part using the brokering knowledge ontology 140 of FIG. 2A.

In some implementations, the transaction elements, organized according to their contextual relationships and rules, are presented to a remote user for confirmation and/or correction (418). The transaction elements, for example, may be arranged in a graphical user interface by the broker feedback interface unit 214 of FIG. 2A and/or FIG. 2B.

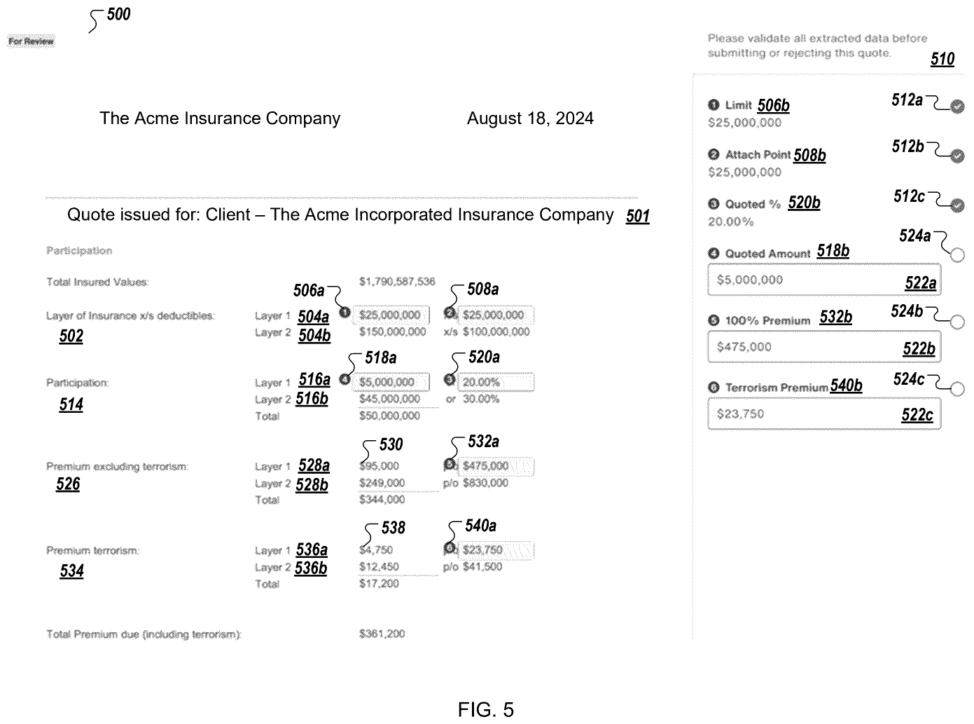

Turning to FIG. 5, in illustration, an example user interface 500 for enabling end user confirmation and/or adjustment of semantically linked transactional information is shown. The example user interface 500 presents quote data extracted from a document that has been arranged according to its relationships. The user interface 500 may have been generated by the broker feedback interface unit 214 of FIG. 2A and/or FIG. 2B. For example, certain information may have been already validated by the end user such that the user interface lacks interactive controls for updating that information. Other information may be modifiable in a future feedback interface (e.g., such as the feedback interface generated using the anomalous document attributes 236 of FIG. 2B in comparison to the feedback interface presenting the grouped document attributes 224 of FIG. 2A or the feedback interface presenting the document attributes 210 of FIG. 2A.

As represented in a quote presentation pane 501 of the example user interface 500, certain values have been linked to transactional properties (e.g., descriptors) as well as to quote layers. For example, a first semantic pairing labels a first layer 504a of insurance deductibles 502 as including a limit 506a of $25,000,000, and a second semantic pairing labels an attachment point 508a of $25,000,000. In a validation pane 510 on the right side of the user interface 500, the limit 506b and attachment point 508b are listed for user review and approval. As illustrated, the limit 506b and the attachment point 508b have been approved according to a green checkmark 512a, b next to each.

Returning to the quote presentation pane 501, the insurance deductibles 502 additionally includes a second layer 504b, not labeled for validation. The second layer 504b, for example, may contain information derived from a separate document (e.g., already validated by the end user).

In another example, a first layer 516a of participation 514 is semantically paired to a quoted amount 518a and a quoted percentage 520a. As shown in the validation pane 510, the quoted percentage 520b (e.g., 20%) has been approved according to a green checkmark 512c, while the quoted amount 518b (e.g., $5,000,000) is illustrated in a text box 522a for adjustment. An unselected checkbox 524a is provided for approval of the present amount or for a newly entered value.

Returning to the quote presentation pane 501, the participation 514 additionally includes a second layer 516b, not labeled for validation. The second layer 516b, for example, may contain information derived from a separate document (e.g., already validated by the end user).

Turning to a premium excluding terrorism section 526 of the quote presentation pane 501, a first layer 528a includes a first value 530 lacking a semantic link, and a second value 532a that is semantically paired to a 100% premium 532b. The first value 530, for example, may represent a value quoted in a separate document (e.g., already validated by the user). As shown in the validation pane 510, the 100% premium 532b value (e.g., $475,000) is illustrated in a text box 522b for adjustment. An unselected checkbox 524b is provided for approval of the present amount or for a newly entered value.

The premium excluding terrorism section 526 also includes a second layer 528b, not labeled for validation. The second layer 528b, for example, may contain information derived from a separate document (e.g., already validated by the end user).

Turning to a premium terrorism section 534 of the quote presentation pane 501, a first layer 536a includes a first value 538 lacking a semantic link, and a second value 540a that is semantically paired to a terrorism premium 540b. The first value 538, for example, may represent a value quoted in a separate document (e.g., already validated by the user). As shown in the validation pane 510, the terrorism premium 540b value (e.g., $23,750) is illustrated in a text box 522c for adjustment. An unselected checkbox 524c is provided for approval of the present amount or for a newly entered value.

The premium terrorism section 534 also includes a second layer 536b, not labeled for validation. The second layer 536b, for example, may contain information derived from a separate document (e.g., already validated by the end user).

Returning to FIG. 4, in some implementations, if one or more modifications are received via presentation to the remote user (420), one or more master data models are updated (422). As illustrated in FIG. 5, for example, the information may be modified through adjusting values within the text boxes 522a-c. The modifications may be used to continue the learning process of one or more machine learning models and/or artificial intelligence networks to better identify information culled from quote documents in the future. For example, the modified grouped document attributes 228 of FIG. 2A may be used to update the training of the ML model(s)/business ontology 220 and/or the AI neural network(s) 232.

Although described in relation to a particular set of operations, in other embodiments, the method 400 may include more or fewer operations. For example, the method 400 may include storing the original document for future reference and/or training purposes. Further, although described as a particular series of operations, in other embodiments, certain operations of the method 400 may be performed in a different order and/or concurrently. For example, as document contents are recognized and tagged (406), they may additionally be converted to vector format (408) in a concurrent processing pipeline. Other modifications of the method 400 are possible.

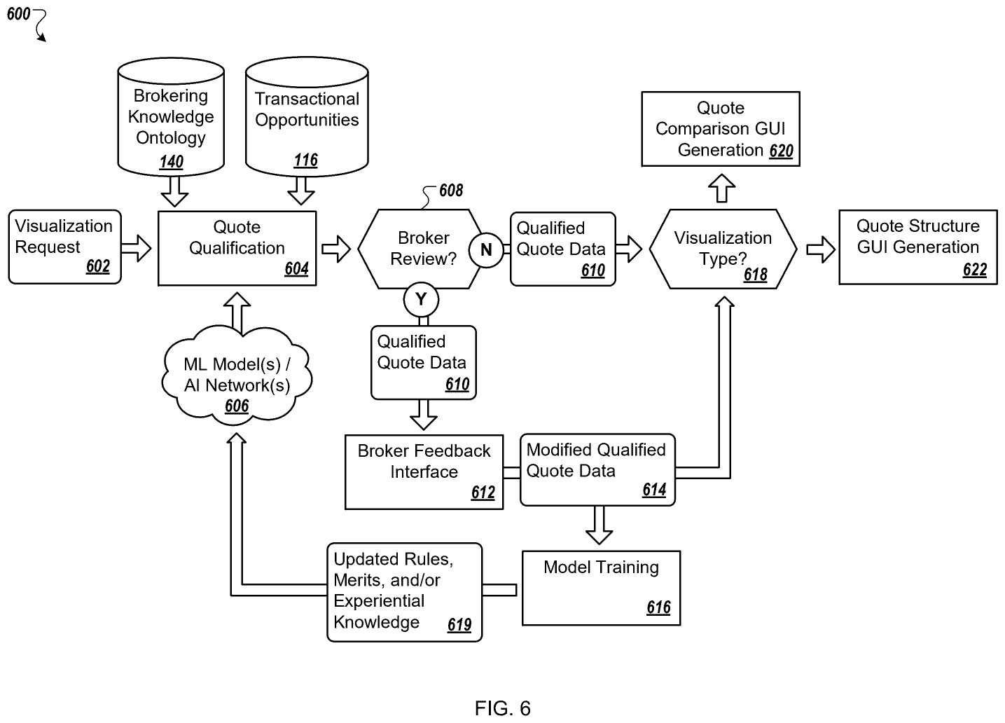

FIG. 6 is a flow diagram of an example process 600 for qualifying semantically linked transactional information and applying the qualified transactional information in generating transactional visualizations. The process 600, for example, may be performed by the transactional data extraction, analysis, and comparison system 102 of FIG. 1.

In some implementations, the process 600 begins with receiving a visualization request 602. The visualization request 602, for example, may be submitted via a user interface of a broker portal provided by the system 102 or a system in communication with the system 102. In another example, the visualization request 602 may be submitted via an application programming interface (API). The visualization request 602, in a further example, may be automatically generated based on receipt of certain information (e.g., at least two quotes for comparison) and/or a time stamp or timer (e.g., expiration of a period of time for gathering competing quotes). The visualization request 602 may identify a type of visualization, parameters for the visualization, and/or at least one transaction related to the visualization. In illustration, the visualization request 602 may reference a particular provisional structure 130, at least one quote submitted responsive to the provisional structure 130, and/or one or more transactions stored in the transactional opportunities 116 of FIG. 1. In some examples, the visualization request may include a quote comparison request, a coverage comparison request, an insurance program schematic request, and/or a “mud map” request.

The various processing units (e.g., engines) of the process 600, in some embodiments, are configured as software routines or processes (e.g., at least a portion of a software program) coded as instructions (e.g., software code) for executing on processing circuitry, such as one or more processors. Certain processing units or operations performed by certain processing units, in some embodiments, are configured as hardware logic (e.g., hardware-based operations) hard-coded or programmed into processing circuitry (e.g., logic circuitry), such as, in some examples, a programmable logic chip or other programmable logic device, an application-specific integrated circuit (ASIC), or a customized processor device. In an illustrative example, a software routine or process component of one of the processing units may provide data and/or variable values (e.g., within a non-transitory computer-readable medium) for use by hardware logic of that processing unit.

In some implementations, when the visualization request 602 relates to comparing quotes and/or recommending, from quote options, one or more best options for fulfilling a client's insurance coverage needs, a quote qualification unit 604 collects, from the transactional opportunities 116, transactional information corresponding to at least two quotes (e.g., according to any parameters provided within the visualization request 602). The quote qualification unit 604 may further collect client requirements, such as the provisional structure 130 of FIG. 1, to ensure the recommendation or comparison takes into consideration the originally captured risk coverage requirements of the client. The quote qualification unit 604, for example, may perform a portion of the operations described in relation to the quote qualification engine 132 of FIG. 1.

In some implementations, the quote qualification unit 604 applies business rules, merits (e.g., pro's and con's), and/or experiential knowledge to score, rate, and/or rank the different quote options. The quote qualification unit 604, for example, may supply gathered information (e.g., the transactional opportunities 116, etc.) to one or more machine learning models and/or artificial intelligence networks 606 trained and/or fine-tuned in business rules, merits, and/or experiential knowledge related to quote comparison and quote selection. The risk fulfillment experiential knowledge, in some examples, may be gleaned through a corpus of historic transactions involving a same carrier, a same risk coverage product type, and/or a same client entity. The ML model(s) and/or AI network(s) 606, for example, may be trained or fine-tuned in view of a collection of historic risk coverage structures and quote offers. The AI network(s) 606, for example, may include at least one large language model (LLM). The ML model(s) and/or AI network(s) 606, for example, may apply a portion of the brokering knowledge ontology 140 as truth data along with the transactional opportunities 116 to apply relevant learned knowledge in assessing the various quote options. The learned knowledge, in another example, may include historically rejected quotes as well as historically accepted quotes (e.g., from a set of quote options presented to a broker for review). The rejections in comparison to acceptances, in some examples, may be refined, in the training of the ML model(s) and/or AI network(s) 606, to focus on historical quote selection behaviors in view of categorical similarities such as, in some examples, geographical region(s), particular broker or broking organization, business line(s), and/or risk category(ies). The ML model(s) and/or AI network(s) 606 may provide one or more scores, ranks, and/or ratings to each quote option. For example, various factors of different quotes may be scored or rated separately, while an overall assessment balances the merits according to the collection of factors.

If broker review is desired (608), in some implementations, a set of qualified quote data 610 may be provided to a broker feedback interface unit 612 (e.g., such as the broker feedback interface unit 214 of FIG. 2A) to present an end user (e.g., broker) with factors of the analysis (e.g., scores, rankings, and/or ratings). The broker feedback interface 612, for example, may provide the end user with the opportunity to adjust one or more scores, rankings, and/or ratings based on the broker's knowledge and experience. If the end user opts to modify one or more factors of the qualified quote data 610 presented via the broker feedback interface unit 612, in some implementations, modified qualified quote data 614 is generated.

A model training unit 616, in some implementations, trains or fine-tunes at least one of the one or more ML model(s) and/or AI network(s) 606 according to the modified qualified quote data 614. For example, the training or fine-tuning may involve adjustments to initially trained rules, merits, and/or experiential knowledge 618.

In some implementations, the qualified quote data 610 and/or modified qualified quote data 614 is provided for generating an end user visualization according to a visualization type 619 identified in the visualization request 602. As illustrated, two example graphical user interface options are provided via a quote comparison GUI generation unit 620 and a quote structure GUI generation unit 622. In other embodiments, different and/or additional GUI generation units may be provided. The various graphical user interfaces, in some examples, may provide the end user (e.g., broker) with the opportunity to review highlighted gaps in the requested coverage (e.g., aspects of the provisional structure 130 of FIG. 1 not addressed in quotes provided by various carriers 120), identify changes between requested quote parameters and actual quoted values, select a subset of the quotes to include in a client proposal, and/or create and save a client proposal.

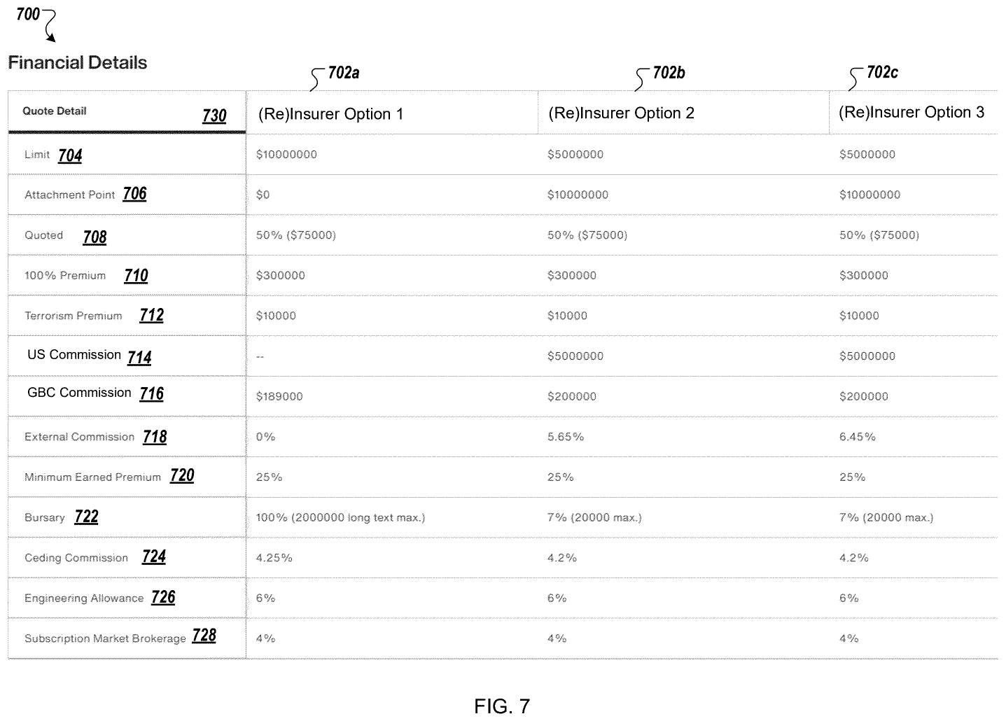

Turning to the quote comparison GUI generation unit 620, as described in relation to the quote comparison engine 136 of FIG. 1, a comprehensive assessment between various quoted options collected in an effort to fulfill a client's risk coverage needs (e.g., according to the provisional structure 130 of FIG. 1) may be generated. The assessment, for example, may be similar in form to that illustrated in an example quote comparison graphical user interface 700 of FIG. 7.

Turning to FIG. 7, the user interface 700 illustrates a comparison between three separate quotes 702a-c received from three different organizations. For simplicity and legibility, only three quotes have been illustrated. However, in practice, a larger number of quotes may be presented, depending upon the number of responses received. Further, in some embodiments, a same organization may have provided multiple risk fulfillment options, resulting in multiple quotes related to the same organization. The individual quotes may be presented, in some examples, in alphabetical order (e.g., by (re)insurance carrier name), in order of receipt, in order of compatibility with the requested product parameter(s), and/or in order of a ranking or rating applied by the analysis and comparison system (e.g., the system 102 of FIG. 1).

The quote comparison of the user interface 700 is illustrated to demonstrate variances in values associated with a number of quote factors such as, in some examples, a limit amount 704, an attachment point amount 706, a quoted amount 708, a 100% premium amount 710, a terrorism premium amount 712, a U.S. commission amount 714, a GBC commission amount 716, an external commission percentage 718, a minimum earned premium percentage 720, a bursary percentage (and maximum) 722, a ceding commission percentage 724, an engineering allowance percentage 726 and a subscription market brokerage percentage 728. The individual factors may differ based on the type of (re)insurance product being offered.

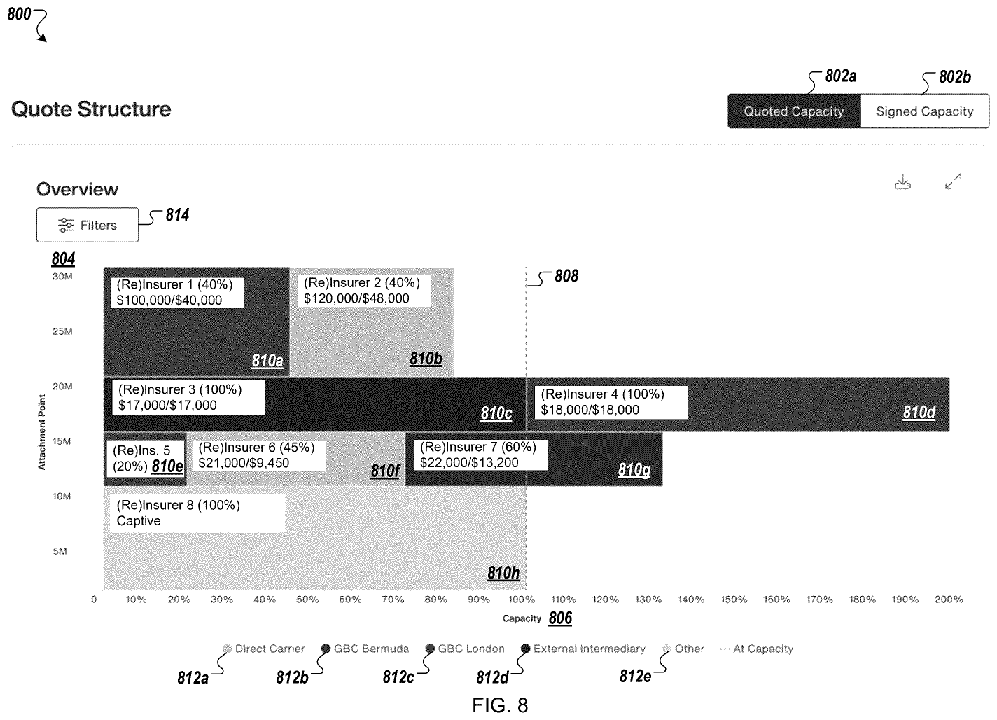

Returning to FIG. 6, if the visualization type 618 is instead a quote structure type, the quote structure GUI generation 622 may generate a graphical representation of an insurance coverage structure representing quotes offered by one or more carriers within the documents, as described in relation to the quote structure generating engine 138 of FIG. 1. The insurance coverage structure, for example, may be similar in form to that illustrated in an example insurance coverage structure graphical user interface 800 of FIG. 8.

Turning to FIG. 8, the user interface 800 illustrates a quote structure representing an alignment of quotes 810a-h, such as the quotes represented in the quote comparison of the user interface 700, within the constructs of the client's desired capacity at a set of attachment points. The quote structure, for example, may be referred to as a “mud map,” allowing the end user to consider the available quotes 810a-h within the client risk fulfillment needs.

As illustrated, each quote 810a-h is arranged at a corresponding quoted attachment point 804, and each quote 810a-h is arranged to visually demonstrate its ability to fulfill the desired capacity 806 at the attachment point. For example, at the 20M-30M attachment point, the first quote 610a and the second quote 810b are insufficient to fulfill a 100% capacity 808, while at the 15M-20M attachment point, each illustrated quote is adequate alone to fulfill the capacity 808. In addition, each quote 810a-h of the arrangement is color-coded according to a source 812a-e, including a direct carrier 812a, GBC Bermuda 812b, GBC London 812c, external intermediary 812d, and other 812e.

A filter control 814 may be used to refine the arrangement according to additional user-selected parameters. In illustration, the filter control may provide filtering to remove one or more of the sources 812a-e from consideration. Further, the filter control may provide filtering according to one or more of the quote factors, such as the quote factors illustrated in a quote detail column 730 of the user interface 700 of FIG. 7.

While illustrated in terms of quoted capacity 802a, in some embodiments, a signed capacity control 802b may be selected to review offers already accepted by the client. The accepted (signed) quotes, for example, may be deducted from the total capacity of the quote structure represented in the user interface 800 of FIG. 8, such that only remaining unfulfilled risk coverage is considered.

Reference has been made to illustrations representing methods and systems according to implementations of this disclosure. Aspects thereof may be implemented by computer program instructions. These computer program instructions may be provided to a processor of a general-purpose computer, special purpose computer, or other programmable data processing apparatus and/or distributed processing systems having processing circuitry, such that the instructions, which execute via the processor of the computer or other programmable data processing apparatus, create means for implementing the functions/operations specified in the illustrations.

One or more processors can be utilized to implement various functions and/or algorithms described herein. The processor(s), for example, may execute processing logic (e.g., software logic, hardware logic, and/or firmware logic) to implement various functions and/or algorithms. Additionally, any functions and/or algorithms described herein can be performed upon one or more virtual processors. The virtual processors, for example, may be part of one or more physical computing systems such as a computer farm or a cloud drive.

Aspects of the present disclosure may be implemented by software logic, including machine readable instructions or commands for execution via processing circuitry. The software logic may also be referred to, in some examples, as machine readable code, software code, or programming instructions. The software logic, in certain embodiments, may be coded in runtime-executable commands and/or compiled as a machine-executable program or file. The software logic may be programmed in and/or compiled into a variety of coding languages or formats.

Aspects of the present disclosure may be implemented by firmware logic, including machine-level instructions or commands (e.g., microcode) for execution via processing circuitry. The firmware logic, for example, may be considered to be a specialized subset of the software logic. The firmware logic, for example, is defined using low level instruction sets and stored to a non-volatile computer-readable memory configured for infrequent updating.

Aspects of the present disclosure may be implemented by hardware logic (where hardware logic naturally also includes any necessary signal wiring, memory elements and such), with such hardware logic able to operate without active software involvement beyond initial system configuration and any subsequent system reconfigurations (e.g., for different object schema dimensions). The hardware logic may be synthesized on a reprogrammable computing chip such as a field programmable gate array (FPGA) or other reconfigurable logic device. In addition, the hardware logic may be hard coded onto a custom microchip, such as an application-specific integrated circuit (ASIC). In other embodiments, software, stored as instructions to a non-transitory computer-readable medium such as a memory device, on-chip integrated memory unit, or other non-transitory computer-readable storage, may be used to perform at least portions of the herein described functionality.

Various aspects of the embodiments disclosed herein are performed on one or more computing devices, such as a laptop computer, tablet computer, mobile phone or other handheld computing device, or one or more servers. Such computing devices include processing circuitry embodied in one or more processors or logic chips, such as a central processing unit (CPU), graphics processing unit (GPU), field programmable gate array (FPGA), application-specific integrated circuit (ASIC), or programmable logic device (PLD). Further, the processing circuitry may be implemented as multiple processors cooperatively working in concert (e.g., in parallel) to perform the instructions of the inventive processes described above.

The process data and instructions used to perform various methods and algorithms derived herein may be stored in non-transitory (i.e., non-volatile) computer-readable medium or memory. The claimed advancements are not limited by the form of the computer-readable media on which the instructions of the inventive processes are stored. For example, the instructions may be stored on CDs, DVDs, in FLASH memory, RAM, ROM, PROM, EPROM, EEPROM, hard disk or any other information processing device with which the computing device communicates, such as a server or computer. The processing circuitry and stored instructions may enable the computing device to perform, in some examples, the process 200 of FIG. 2A and FIG. 2B, the method 300 of FIG. 3, the method 400 of FIG. 4, and/or the process 600 of FIG. 6.

These computer program instructions can direct a computing device or other programmable data processing apparatus to function in a particular manner, such that the instructions stored in the computer-readable medium produce an article of manufacture including instruction means which implement the function/operation specified in the illustrated process flows.

Embodiments of the present description rely on network communications. As can be appreciated, the network can be a public network, such as the Internet, or a private network such as a local area network (LAN) or wide area network (WAN) network, or any combination thereof and can also include PSTN or ISDN sub-networks. The network can also be wired, such as an Ethernet network, and/or can be wireless such as a cellular network including EDGE, 3G, 4G, and 5G wireless cellular systems. The wireless network can also include Wi-Fi®, Bluetooth®, Zigbee®, or another wireless form of communication. The network, for example, may support communications between the user devices 106 and the system 102 of FIG. 1, between the broker feedback interface unit 214 and the user device in communication with the display 216 of FIG. 2A, between the semantic group enrichment unit 230 and the AI neural network(s) 232 of FIG. 2B, between the document attribute extraction unit 208 and the machine learning model(s) and/or business ontology 220 of FIG. 2A, between the quote qualification unit 604 and the brokering knowledge ontology 140 and/or transactional opportunities data store 116 of FIG. 6, and/or between the model training unit 616 and/or the quote qualification unit 604 and the machine learning model(s) and/or AI network(s) 606 of FIG. 6.

The computing device, in some embodiments, further includes a display controller for interfacing with a display, such as a built-in display or LCD monitor. A general purpose I/O interface of the computing device may interface with a keyboard, a hand-manipulated movement tracked I/O device (e.g., mouse, virtual reality glove, trackball, joystick, etc.), and/or touch screen panel or touch pad on or separate from the display. The display controller and display may enable presentation of the screen shots illustrated, in some examples, in FIG. 5, FIG. 7, and/or FIG. 8.

Moreover, the present disclosure is not limited to the specific circuit elements described herein, nor is the present disclosure limited to the specific sizing and classification of these elements. For example, the skilled artisan will appreciate that the circuitry described herein may be adapted based on changes in battery sizing and chemistry or based on the requirements of the intended back-up load to be powered.

The functions and features described herein may also be executed by various distributed components of a system. For example, one or more processors may execute these system functions, where the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system, in some examples, may be received via direct user input and/or received remotely either in real-time or as a batch process.

Although provided for context, in other implementations, methods and logic flows described herein may be performed on modules or hardware not identical to those described. Accordingly, other implementations are within the scope that may be claimed.

The cloud computing environment may also include one or more databases or other data storage, such as cloud storage and a query database. In some implementations, the cloud storage database, such as the Google™ Cloud Storage or Amazon™ Elastic File System (EFS™), may store processed and unprocessed data supplied by systems described herein. The databases may include one or more vector databases organized to store high-dimensional data points each mathematically representing the meaning and context of at least a portion of an original file (e.g., text document, audio file, rich media file, image file, photograph, video file, etc.). The vector database(s), for example, may incorporate a set of search algorithms for performing vector similarity searches such as, in some examples, an exhaustive k-nearest neighbors (KNN) algorithm, an approximate nearest neighbor (ANN) algorithm, a Locality Sensitive Hashing (LSH) algorithm, a Hierarchical Navigable Small World (HNSW), and/or an Inverted File Index (IVF) algorithm. The vector database(s), further, may include an embedded query engine for submitting a request to the vector database(s). Unlike traditional databases and query systems, for example, a vector database query may respond with a set of similar assets (e.g., objects or items) to the query information based on similarity metrics (e.g., as calculated by the set of search algorithms). The vector database(s), in some examples, may be implemented by Microsoft® Azure Cosmos DB or Cloudflare Vectorize by Cloudflare, Inc. of San Francisco, CA. For example, the contents of the document collection 104, the transactional opportunities 116, the brokering knowledge ontology 140, and/or the business data store 114 of FIG. 1 may be maintained in a database structure.

The systems described herein may communicate with the cloud computing environment through a secure gateway. In some implementations, the secure gateway includes a database querying interface, such as the Google BigQuery™ platform or Amazon RDS™. The secure gateway may include a vector database querying interface, such as Microsoft® Azure AI Search or Vertex AI Vector Search by Google®. The data querying interface, for example, may support access by the document attribute extraction unit 208 of FIG. 2A to the business ontology 220, the semantic grouping of attributes unit 222 to the brokering knowledge ontology 140, and/or the semantic group enrichment unit 230 and/or the broker feedback interface unit 214 to the transactional opportunities data store 116. The data querying interface, in further examples, may support access by the quote qualification unit 604 to the brokering knowledge ontology 140 and/or transactional opportunities 116.

In some implementations, an edge server is used to transfer data between one or more computing devices and a cloud computing environment according to various embodiments described herein. The edge server, for example, may be a computing device configured to execute processor intensive operations that are sometimes involved when executing machine learning processes, such as operations performed by the document attribute extraction unit 208 and/or the semantic group enrichment unit 230 of FIG. 2B, and/or the quote qualification unit 604, and/or the model training unit 616 of FIG. 6. An edge server may include, for example, one or more GPUs that are capable of efficiently executing matrix operations as well as substantial cache or other high-speed memory to service the GPUs. An edge server may be a standalone physical device. An edge server may be incorporated into other computing equipment, such as a laptop computer, tablet computer, medical device, or other specialized computing device. Alternatively or additionally, an edge server may be located within a carrying case for such computing equipment. An edge server, in a further example, may be incorporated into the communications and processing capabilities of a mobile unit such as a vehicle or drone, or may otherwise be located within the mobile unit.

In some implementations, the edge server communicates with one or more local devices to the edge server. The edge server, for example, can be used to move a portion of the computing capability traditionally shifted to a cloud computing environment into the local environment so that any computation intensive data processing and/or analytics required by the one or more local devices can run accurately and efficiently. In some embodiments, the edge server is used to support the one or more local devices in the absence of a connection with a remote computing environment. The edge server may be configured to communicate with the one or more local devices directly or via a network. For instance, the edge server can include a private wireless network interface, a public wireless network interface, and/or a wired interface through which the edge server can communicate with the one or more local devices. In some embodiments, certain local devices may be configured to communicate indirectly with the edge server, for example via another local device. Further, the edge server may be configured to communicate with a remote computing (e.g., cloud) environment via one or more public or private wireless network interfaces.

In some implementations, the process 200 of FIG. 2A and FIG. 2B, the method 300 of FIG. 3, the method 400 of FIG. 4, and/or the process 600 of FIG. 6 may be configured to be performed in part by an edge server or a device interoperating with an edge server. The device interoperating with the edge server, for example, may share processing functionality with the edge server via one or more APIs implemented by the processes.

The systems described herein may include one or more artificial intelligence (AI) neural networks for performing automated analysis of data. The AI neural networks, in some examples, can include a synaptic neural network, a deep neural network, a transformer neural network, and/or a generative adversarial network (GAN). The AI neural networks may be trained using one or more machine learning techniques and/or classifiers such as, in some examples, anomaly detection, clustering, and/or supervised and/or association. In one example, the AI neural networks may be developed and/or based on a bidirectional encoder representations for transformers (BERT) model by Google of Mountain View, CA.

The systems described herein may communicate with one or more foundational model systems (e.g., artificial intelligence neural networks). The foundational model system(s), in some examples, may be developed, trained, tuned, fine-tuned, and/or prompt engineered to evaluate data inputs such as the emails 110a, attachments 110b, shared documents 110c, and/or voice messages 110d of FIG. 1, the contents of the transactional opportunities 116 of FIG. 1, the brokering knowledge ontology 140 of FIG. 1, and/or the business ontology 220 of FIG. 2A. The foundational model systems, in some examples, may include or be based off of the generative pre-trained transformer (GPT) models available via the OpenAI platform by OpenAI of San Francisco, CA (e.g., GPT-3, GPT-3.5, and/or GPT-4) and/or the generative AI models available through Azure OpenAI or Vertex AI by Google of Mountain View, CA (e.g., PaLM 2).

Certain foundational models may be fine-tuned as AI models trained for performing particular tasks required by the systems described herein. Training material, for example, may be submitted to certain foundational models to adjust the training of the foundational model for performing types of analyses described herein.

Multiple foundational model systems may be applied by the systems and methods described herein depending on context. The context, for example, may include type(s) of data, type(s) of response output desired (e.g., at least one answer, at least one answer plus an explanation regarding the reasoning that lead to the answer(s), etc.). In another example, the context can include user-based context such as demographic information, entity information, and/or product information. In some embodiments, a single foundational model system may be dynamically adapted to different forms of analyses requested by the systems and methods described herein using prompt engineering.

While certain embodiments have been described, these embodiments have been presented by way of example only and are not intended to limit the scope of the present disclosure. Indeed, the novel methods, apparatuses and systems described herein can be embodied in a variety of other forms; further, various omissions, substitutions and/or changes in the form of the methods, apparatuses and systems described herein can be made without departing from the spirit of the present disclosure. The accompanying claims and their equivalents are intended to cover such forms or modifications as would fall within the scope and spirit of the present disclosure.

What is claimed is:

1. A system for extracting, and organizing, and visualizing details of risk fulfillment options provided by multiple third parties in response to a risk fulfillment transaction request, the system comprising:
at least one non-transitory computer-readable storage medium storing
a business ontology comprising a plurality of terms and a plurality of business rules, each business rule defining relationships between a respective set of terms of the plurality of terms, and
a semantic ontology defining risk fulfillment information, the semantic ontology comprising
a hierarchy of risk fulfillment terms,
a plurality of risk fulfillment rules, each risk fulfillment rule applied to at least one term of the hierarchy of risk fulfillment terms, and
a plurality of relationships between sets of terms of the hierarchy of risk fulfillment terms;
a non-transitory computer-readable data store configured to store a semantic graph; and
processing circuitry configured to perform a plurality of operations, the operations comprising
accessing, from a non-transitory computer-readable data store, a plurality of documents, each document of the plurality of documents corresponding to a respective risk fulfillment transaction of a plurality of risk fulfillment transactions, wherein
each respective document of the plurality of documents originated from a respective risk coverage entity of a plurality of risk coverage entities, for each respective document of the plurality of documents,
converting unstructured contents of the respective document into standard formatting,
applying the business ontology to recognize and tag each transaction element of a respective plurality of transaction elements within the respective document with a respective tag of a plurality of tags, each tag corresponding to a respective term of the plurality of terms of the business ontology, and
storing the respective plurality of transaction elements into the semantic graph according to the plurality of relationships of the semantic ontology,
enhancing a portion of the plurality of transaction elements stored to the semantic graph with attributes, wherein the enhancing comprises
analyzing the semantic graph to recognize a plurality of relationships, each relationship being between a respective set of transaction elements from a respective two or more different documents of the plurality of documents, and
updating the semantic graph to capture the plurality of relationships as a plurality of relational links,
presenting, for review at a first display of a first computing device, an interactive graphical user interface comprising, for each respective transaction element of a set of transaction elements of the plurality of transaction elements,
a respective value,
a respective text label, the respective text label explanative of the respective tag applied to the respective transaction element, and
at least one respective interactive control configured to enable a user of the first computing device to adjust the respective value,
wherein the set of transaction elements correspond to a subject risk fulfillment transaction of the plurality of risk fulfillment transactions,
receiving, via the interactive graphical user interface, adjustment of the respective value of at least one transaction element of the set of transaction elements,
updating the semantic graph according to the adjustment, and
generating, for review at a second display of a second computing device, a visualization of a plurality of options for fulfilling the subject risk fulfillment transaction on behalf of a client entity, each option of the plurality of options corresponding to a respective subset of transaction elements of the plurality of transaction elements, each transaction element of the respective subset of transaction elements corresponding to the subject risk fulfillment transaction.

2. The system of claim 1, wherein the second computing device is the first computing device.

3. The system of claim 1, wherein the operations further comprise, prior to storing the respective plurality of transaction elements into the semantic graph, converting the respective plurality of transaction elements to a vector format.

4. The system of claim 1, wherein tagging the respective plurality of transaction elements comprises logically applying, to each transaction element of the respective plurality of transaction elements, a respective label corresponding to a respective term of a plurality of terms in the business ontology.

5. The system of claim 1, wherein enhancing the portion of the plurality of transaction elements comprises importing, to each respective transaction element of the portion of the plurality of transaction elements, one or more respective characteristics from one or more similar transaction elements determined, according to the plurality of relationships, to be related to the respective transaction element.

6. The system of claim 1, wherein enhancing the portion of the plurality of transaction elements comprises applying at least one of i) one or more machine learning models trained in a business knowledge or ii) one or more artificial intelligence networks fine-tuned in the business knowledge to add one or more respective characteristics to each transaction element of the portion of the plurality of transaction elements according to the business knowledge.

7. The system of claim 1, wherein the plurality of documents comprises a plurality of unstructured email documents.

8. The system of claim 6, wherein the plurality of operations further comprise, prior to applying the business ontology, identifying, within each document of the plurality of documents, a respective transaction identifier corresponding to the subject risk fulfillment transaction.

9. The system of claim 1, wherein the business ontology is stored as a resource description framework (RDF).

10. The system of claim 1, wherein the semantic ontology defines insurance quote information related to at least one type of insurance quote.

11. The system of claim 1, wherein a portion of the plurality of relational links connect transaction elements related to a same risk fulfillment transaction of the plurality of risk fulfillment transactions.

12. The system of claim 1, wherein converting the unstructured contents of the respective document into the standard formatting comprises applying natural language processing to the unstructured contents.

13. The system of claim 1, wherein generating the visualization of the plurality of options for fulfilling the subject risk fulfillment transaction comprises submitting the plurality of options to at least one of i) one or more machine learning models trained with a corpus of risk fulfillment experiential knowledge or ii) one or more artificial intelligence networks fine-tuned with the corpus of risk fulfillment experiential knowledge to obtain an assessment of a respective value of each option of the plurality of options, wherein the corpus of risk fulfillment experiential knowledge comprises fulfillment options and offer acceptances related to a plurality of historic risk fulfillment transaction requests.

14. The system of claim 13, wherein the respective value comprises a relative ranking in view of the plurality of options.

15. The system of claim 13, wherein the assessment is based in part on a provisional structure representing risk coverage requirements of the client entity for the subject risk fulfillment transaction.

16. The system of claim 1, wherein generating the visualization of the plurality of options for fulfilling the subject risk fulfillment transaction comprises arranging the plurality of options as a color-coded mud map.

17. A method for extracting, and organizing, and visualizing details of risk fulfillment options provided by multiple third parties in response to a risk fulfillment transaction request, the method comprising:
accessing, from a non-transitory computer-readable data store, a plurality of documents, each document of the plurality of documents corresponding to a subject risk fulfillment transaction, wherein
each respective document of the plurality of documents originated from a respective risk coverage entity of a plurality of risk coverage entities;
for each respective document of the plurality of documents, by processing logic comprising at least one of hardware logic integrated into and executable by one or more processors, software logic stored in at least one non-transitory computer-readable medium and executed by the one or more processors, or firmware logic integrated into and executable by the one or more processors,
arranging contents of the respective document into a respective plurality of quote aspects, wherein each quote aspect of the respective plurality of quote aspects is tagged with a respective classification of a plurality of classifications according to a quote classification schema,
semantically grouping subsets of the respective plurality of quote aspects, and
storing the respective plurality of quote aspects into a non-transitory computer-readable transactional opportunities data store, wherein storing comprises logically linking each semantically grouped subset of the respective plurality of quote aspects;
enhancing, by the processing logic, a portion of the plurality of quote aspects with attributes, wherein
the attributes comprise one or more of an identification of a quote layer, a description of a quote layer, an identification of a quote limit, a description of a quote limit, or a description of coverage details, and
the enhancing comprises applying at least one of i) one or more machine learning models trained in a business knowledge or ii) one or more artificial intelligence networks fine-tuned in the business knowledge to add one or more respective characteristics to each quote aspect of the portion of the plurality of quote aspects according to the business knowledge; and
generating, by the processing logic for review at a display of a computing device, a visualization of a plurality of options for fulfilling the subject risk fulfillment transaction on behalf of a client entity, each option of the plurality of options corresponding to a respective subset of quote aspects of the plurality of quote aspects, wherein
for each option of the plurality of options, the visualization comprises a respective value and a respective risk coverage entity of the plurality of risk coverage entities.

18. The method of claim 17, further comprising, prior to enhancing the portion of the plurality of quote aspects, converting, by the processing logic, contents of the transactional opportunities data store to a plurality of vector forms arranged in a logically linked graph, framework, or neural network for ingestion by the one or more artificial intelligence networks.

19. The method of claim 17, further comprising, prior to arranging the contents of the respective document into the respective plurality of quote aspects, converting, by the processing logic, the contents of the respective document into a plain text format.

20. The method of claim 17, further comprising, prior to generating the visualization of the plurality of options, qualifying, by the processing logic, each respective option of the plurality of options in view of one or more client requirements of a set of client requirements for the risk fulfillment transaction request.
